(19) United States
(12) Patent Application Publication
(10) Pub. No.: US 2008/0029346 A1
(43) Pub. Date: Feb. 7, 2008

(54) GO-BETWEEN CONTAINER TRANSFER AND SYSTEM

(76) Inventor: Leonard D. Barry, Detroit, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/733,789

(22) Filed: Apr. 11, 2007

Related U.S. Application Data
(63) Continuation-in-part of application No. 11/536,298, filed on Sep. 28, 2006.
(60) Provisional application No. 60/721,300, filed on Sep. 28, 2005.

(51) Int. Cl. B66F 9/075

(52) U.S. Cl. 187/237; 187/222

(57) ABSTRACT

This invention is a system with carrier for transferring cargo containers between exposed-center-sill container cars and trucks, and docks and conveyors having recesses or wines to receive the carrier for lifting the container from underneath. The carrier has top and bottom frames with top and bottom arms respectively extending over and under the center sill of the car. The lower frame is supported on wheels which on the lower arms are in ring casters to fit under the car sill. Two wheels are mounted to rotate separately on a shaft, one each side of center across the ring of the caster. Only one wheel of each caster being powered for steering. The top arms extend over the center car sill and over the bottom arms of the carrier and fit between platforms on the railway car which supports the ends of the container to align. Air-lift bags on the top arms lift the containers off or set them in place on the car. The top and bottom frames are connected along one side preferably by a lift to lift and lower both the top and bottom arms to support the carrier on the sill of the car. The carrier can be electrically driven and operated as a robot or remotely, or be pushed and pulled about by other means or vehicles. The loader clamps onto the car sill for transport on the car. Optionally separate sets of wheels could be used for lengthwise and sideways movement of the carrier.

### CROSS-REFERENCE TO RELATED APPLICATIONS

This invention is a continuation in part of my pending U.S. application Ser. No. 11/536,298 filed Sep. 28, 2006, which claims priority of U.S. Provisional Patent Application Ser. No. 60/721,300 filed Sep. 28, 2005.

### FIELD OF THE INVENTION

This is a simplified version of my above referenced Under-way Vehicle Transfer patent application now with a carrier for transferring of cargo containers between standing railway cars, trucks, docks and conveyors. The wheels 24 (see FIGS. 35-37) of that application are not mounted to be turned 90° from parallel to the vehicle to steer straight sideways into a standing railway car. Therefore this invention is directed to overcome that shortcoming. That the carrier can transfer containers to and from standing railway cars and trucks is most needed and useful.

### SUMMARY OF THE INVENTION

The main object of this invention is to disperse the concentration of container handling from hub centers to shippers' and consignees' locations, greatly reducing wasting fuel and highway congestion by shipments going by rail directly to destinations, eliminating much wasted intermodal transfer and hauls to and from intermodal yards remote from destinations.

It is an object to provide an underreaching lift carrier to roll under a standing railway car or highway truck to transfer cargo containers or pallets between the railway car, trucks, docks or conveyors.

It is therefore an object to provide a fork-type lift vehicle that extends rollers or wheels under a railway car sill and a fork or platform over the sill to lift from or set down a cargo container or platform on the railway car.

It is an object to provide the transfer carrier with rotary ring casters with an outer horizontal ring with diametrical axle on which wheels on both sides of center rotate separately, those on one side of center being driven so the casters can be easily pivoted to steer. It is an object to turn and hold the swivel casters to steer all wheels in parallel or selectively those at one or either end held parallel to the vehicle while those at the opposite end are steerable. It is an object to provide parallel all wheel caster steering and with wheel axle axis intercepting the vertical swivel axis to steer in one position of the vehicle. It is an object to provide a low cost loader for existing containers.

It is an object to provide a loader that can be hauled on the railway car underneath the container to enable customers without a loader to borrow the loader from the railroad when receiving a container or needing a loader to load the container onto a railway car and return the loader to the railroad locally, i.e. without shipping the loader long distances.

It is an object to provide stations locally to add a transfer carrier under the container on a railway car to carry it to a customer to use it for transferring one or more containers at the customer's location.

It is a further object to provide the carrier as a robot or to be remotely controlled.

It is also an object to provide the carrier as a toy radio operated.

### BRIEF DESCRIPTION OF THE DRAWINGS

These, other and further objects should become evident to those skilled in the art by study of this specification taken with reference to the drawings wherein:

FIG. 1 is a plan view of a transfer driveway with flush imbedded railway track with container cars stopped thereon for transfer of containers between the cars, truck, and dock and conveyor.

FIGS. 2, 3, and 4 are respectively plan, side and end views of a transfer carrier of FIG. 1 with a railway car and containers partly shown to larger scale.

FIG. 5 is an end view of FIG. 3 with the loader lifted on the railway car.

FIG. 6 is a plan view of the near side left corner of FIG. 2 to larger scale.

FIGS. 7 and 8 are respectively elevations taken on lines 7-7 and 8-8 of FIG. 6.

FIG. 9 is an end elevation of the loader at a dock.

FIG. 10 is a perspective of a loader aligned for transfer with a railway car.

FIG. 11 is a side view of the loader and the car of FIG. 10.

FIG. 12 is a side view of a semi-trailer truck to utilize the loader.

FIGS. 13 and 14 are respectively plan and side views of a railway car to work with the loader.

FIGS. 15, 16 and 17 are respectively side, end and bottom views of a double loader for two short or one long container for the car of FIGS. 13 and 14.

FIG. 18 is a bottom view of a variation of the wheel supports on the loader, FIG. 19 a side view.

FIGS. 20 and 21 are respectively plan and side views of a wheel assembly of FIG. 18 for lengthwise running at larger scale.

FIGS. 22 and 23 are respectively plan and side elevations of a support wheel mounting of FIG. 18 for sideways movement of the loader at a larger scale.

FIG. 24 is a bottom view of the shift-to-lift wedge of FIG. 23.

FIG. 25 is an end elevation of the loader of FIGS. 18-19 shown lifted on its wheels for sideways movement with relation to sill and dock.

FIG. 26 is a plan view of a variation of the loader on a separate shuttle car aligned for transfer of a container on the railway car or truck.

FIG. 27 is a side elevation of the loader on the shuttle car of FIG. 26.

FIGS. 28 and 29 are end elevations of respectively the loader on the shuttle and rolled off of the shuttle and located around the sill of the car for transfer of the container.

### DETAILED DESCRIPTION OF THE INVENTION

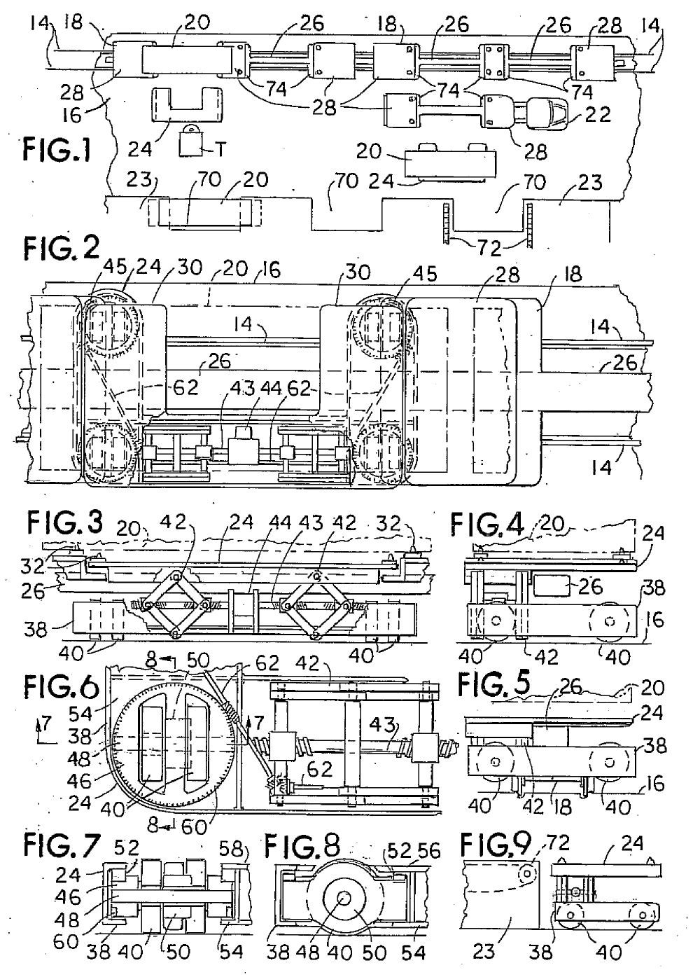

Referring to the drawings and in particular to FIGS. 1-9, track 14 imbedded flush in drive area 16 has railway container cars 18 (spline cars) stopped thereon for transfer of cargo pallets or containers 20 to and from cars 18, truck 22, and dock 23 by means of transfer carriers 24. Various lengths and widths of containers or pallets can be accommodated on cars 18, trucks 22, carriers 24 and on the dock 23 as indicated by phantom lines.

Spline cars 18 each have an exposed center sill 26 connecting platforms 28 for supporting ends of containers 20 at a height above sill 26 for a platform or forks 30 of the transfer vehicle 24 to reach between sill 26 and the bottom of a container whose ends are supported on holding devices 32 on platforms 28 of the car. Outer sides 34 of forks 30 guide (slip fit) between the inner facing faces 36 of platforms 28 to align a container on its berth on the car.

The transfer carrier 24 has a lower frame 38 supported on rollers or wheels 40 to roll on drive area 16 over track 14 and under car sill 26. Two wide diamond jacks 42, one on each end of the carrier 24, are connected between the lower frame 38 and the top fork platform 30. The jacks are connected to operate in unison by the screw shaft 43 driven by gear motor 44 to lift and lower platform forks 30 relative to frame 38 to lift or lower a container on the car and to lift wheels 40 to clear above the track for transport on the car to use by customers to transfer the containers. End rollers 45 on platforms 30 help guide the loader between platforms 28.

The carrier's wheels 40 are mounted in rings, casters 46, one supporting each corner of frame 38 to keep the height of frame 38 where it extends under the railway car 18 to be within the height (diameter) of the wheel 40. One or more wheels 40 are mounted to turn separately on each side of center on axle 48 run diametrically across ring 46 of each caster. An electric gearmotor 50 is connected to drive a wheel or wheels 40 on one side of the axle 48 and is supported by the ring so the caster can be powered and easily steered by turning the ring on its center axis. Each ring 46 is supported to turn on its axis in frame 38 between thrust bearings 52 between two horizontal plates 54 and 56 in aligned circular holes in which the caster ring swivels. Rings 46 each have an integral ring gear 60 on its circumference connected by gearing and shafting 62 to steer the casters in parallel. The shafting is in three sections in the run between the rings 46 at opposite ends of the carrier. A clutch 66 connects each end of the middle run to each end shaft to connect the shaft ends together for all wheel parallel steering and is disconnected for either end front end steering with remote controls and locking the opposite end steering casters in position with wheels 40 parallel to the vehicle.

The truck 22 is a tractor trailer with an open center sill 26 and end platforms 28 and locators 32 for the ends of containers 20 similar as on the railway car 18 and at the same height for transfer of the container.

The dock 23 has one or more recesses 70 sized for the carrier to enter to set a container across the facing sides of the recess. The dock end platforms have infloor conveyor runs 72 to carry the container to and from over the recesses and into a warehouse or factory.

### Operation

The carrier can be run under a container on car 18 the jacks 42 being positioned to clear platform 28 over sill 26 and below the container. When the carrier is fully inserted jacks 42 are lowered (retracted) to lift wheels 40 up off driveway 16 to clear track 14 and clamp the loader on the car by lowering the jacks as far as possible. This can be done at a local railway yard before delivering the container to a customer on rail so when the car is spotted at the customer's location the carrier can be used by the customer to unload and reload the car.

After the customer receives the car over a driveway 16 they extend the carrier's jacks 42 (which were tightly retracted) to unlock the carrier from the car and lower its wheels 40 to driveway 16 and further extends the jacks to lift the container from the car's platform 28 up onto carrier's platform 30 and high enough to clear holding devices 32. The carrier with container thereon is driven or pulled straight out from the car and steered if necessary. It is moved into a recess 70 in the customer's dock 23 carrying the container over ends of the dock to set it down on the dock 23 or conveyor runs 72, FIGS. 1 and 9.

To load the container on the truck the carrier with container is moved straight out from car 18 (no steering needed) to leave room for truck 22 to drive parallel between the car and carrier and align with the carrier, FIG. 1. The carrier is then pushed or driven straight in between end platforms 28 on truck 22 and lowered enough to set the container on the truck and clear its sill 26 before pulling it out from under the truck.

To load empty or reloaded containers on waiting cars 18 or trucks 22 the loader with a container 20 is moved all the way in to the sill 26 between platforms 20 on the vehicle. Next jacks 42 are retracted to set the container on the vehicle's locators 32. As the jacks are retracted further, wheels 40 are lifted clear from driveway 16. As the jacks are retracted more and tighten, the loader is clamped between the top and bottom of sill 26 and rests on end shelves 74 on the facing sides 36 of platforms 28 and keyed or pocketed thereon to hold alignment and provide secure support for the full width of the loader at both ends for travel on the car or truck. The container can be removed from the car or truck or added from above by other means without disturbing the carrier below. The loader preferably is removed from the car locally if owned by the railroad so as to avoid shipping it a long distance along with the container.

### Variations

Similar parts are given the same reference number or a suffix added if modified.

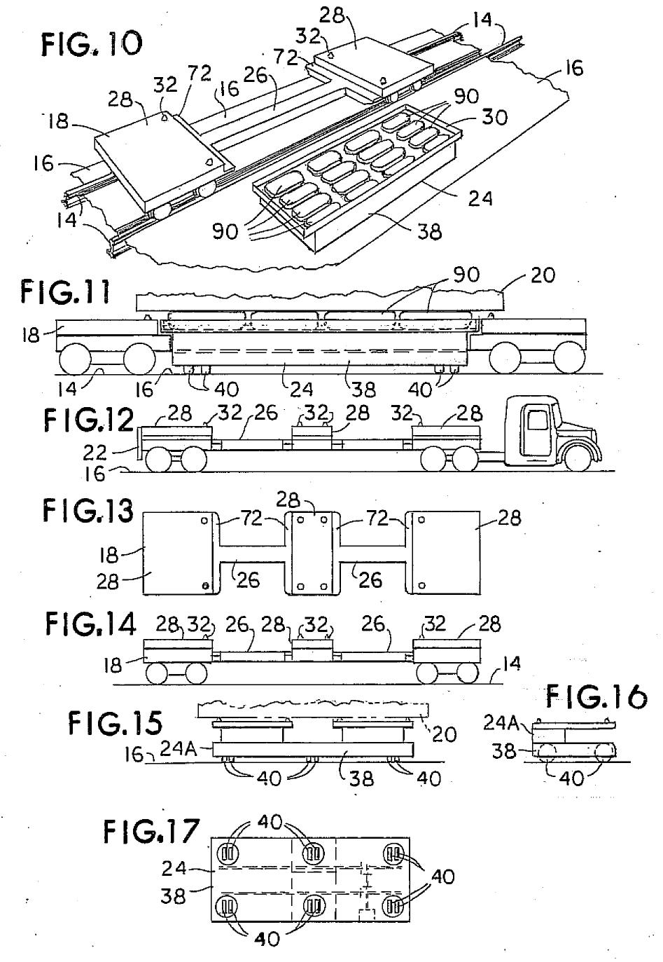

Referring to FIGS. 10-11 the loader can be simplified by eliminating the lift jacks if transport of the loader on the railroad car with the container is not needed. Air lift bags 90 secured on top of platform 30 are connected to be inflated as one to provide lift sufficient for lifting the container to clear over end platforms 28 and locators 32 and deflated for setting the container on the car. The lower frame and the upper platform 30 can then be one to surround top, bottom and one side of sill 26 between platforms 28 between the trucks of the car 18 and the wheels of truck 22.

The loader need not be motorized (motor 50 omitted) but can be moved about, pushed and pulled by a tractor T, FIG. 1, which can supply auxiliary power or air to steer the loader and lift and lower its jacks or air bags. The loader can be battery operated or by an extension cord and remote controls.

The loader can be built for 20 ft or 40-53 ft existing containers or for larger containers which can go all the way by rail not limited by highway restrictions.

Referring to FIGS. 12-17 car 18 or trailer 22 has an intermediate platform 28 for its three platforms 28 to support two 20 ft or one 40-53 ft container. The platforms 28 are spaced apart for the loader to enter between adjacent platforms 28. The loader 24A has a base frame 38 extending between the trucks of car 18 to engage between a plurality of platforms 28 on that car. The lifts 42 or 90 for each berth can be operated separately for the 20 ft containers or simultaneously for the longer loads. The carrier can have more ring casters added to its frame 38 as needed to carry the maximum weight expected. All the casters are connected to steer together.

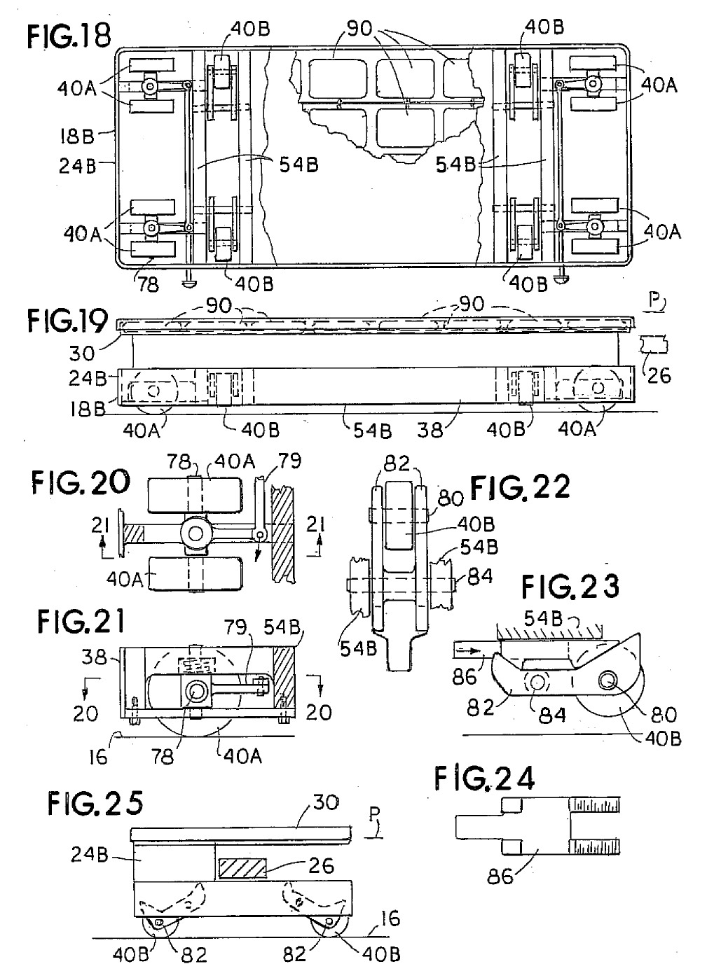

Referring to FIGS. 18-25, loader 18B has wheels 40A mounted spaced apart on the ends of axles 78 and steered by arms and linkage 79 for lengthwise movement of the loader. The loader also has wheels or rollers 40B each mounted on an axle 80 supported between double wedge arms 82 pivot mounted at 84 to frame 54B to lower roller 40B to lift the loader off of wheels 40A to run straight sideways in and out from a vehicle 18, 22, or dock 23. Referring to FIGS. 22-24, a double wedge 86 is mounted in frame 54B to engage both arms 82 to double wedge and to shift straight to the right, FIG. 23, to lower wedge arms 82 for wheels 40B to support the loader and wedge arms 82 to lift when the double wedge slide 86 is shifted back to the left to lift wheels 40B above driveway 16. FIG. 25 shows how much the extension of wheels 40B raises the carrier platform 30 relative to the dock or vehicle platform level P while keeping clear of sill 26. The lift wheels 40B are the sideways running wheels because the liftings and lowerings are made for sideways transfers.

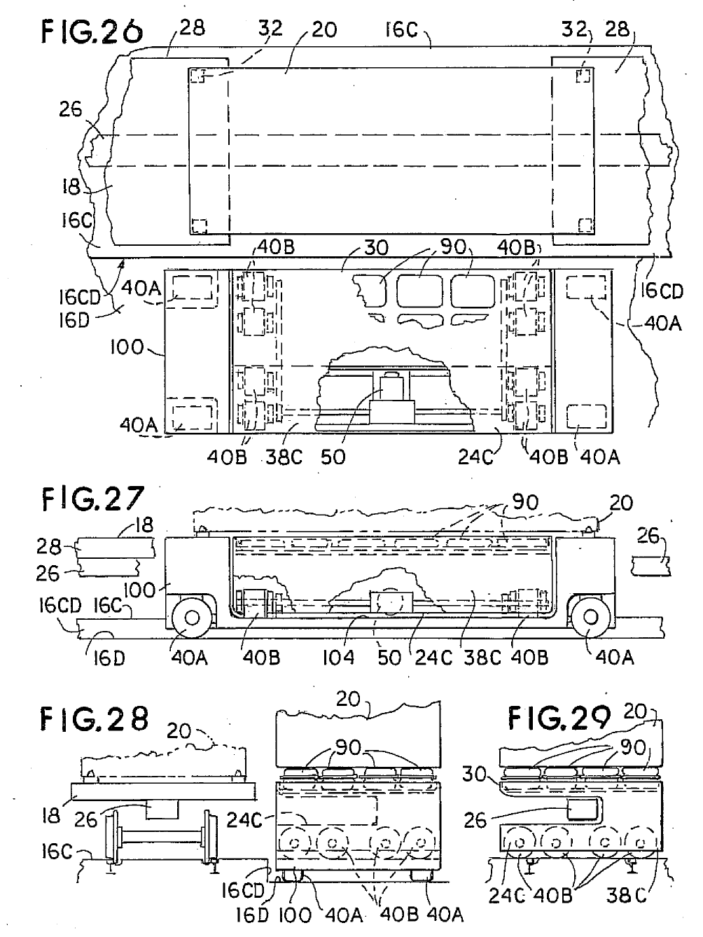

Referring to FIGS. 26-29, loader 24C has the lifting platform 30 mounted on frame 38C to surround top, bottom, and one side of sill 26 of car 18. This loader is supported on several wheels 40B to move sideways. A shuttle car 100 on powered wheels 40A carries the loader lengthwise on driveway 16D along the loading area and steers for road operation. Driveway 16C has a depressed runway 16D for the shuttle car and a paved area flush along track 14 and extending to and along the top edge of wall 16CD extending down to the runway 16D. The shuttle car has a depressed center platform 104 to carry the loader at the height of the upper trackway 16C. Wheels 40B are arranged in line four in a row at each end of the loader 18C to carry the loader over the gap between the shuttle car platform 104 and the paved track elevation 16C. Air bags 90 on platform 30 are inflated and deflated together to lift and lower a container to clear over car 18 or set the container down on the car. Wheels 40A can be steerable, powered, and mounted in a usual manner and can be larger than wheels 40B because they do not need to fit under still 26.

### Operation for FIGS. 26-29

The transfer shuttle 100 with the transfer loader 24C is stopped when aligned with a car 18 with container for transfer. The transfer loader is sent off to straddle the car sill 26 and align with the container above. The air bags are inflated, lifting the container to clear the car, and the transfer loader is returned to the shuttle with the container which it sets on the shuttle when the air bags 90 are deflated, or left inflated for a short ride on the shuttle. The shuttle takes the loader and container to align a dock 23 where the loader with air bags 90 lifted is run off of the shuttle to carry the container over end platforms of dock 23 or across runs of a plate conveyor at the dock. The air bags are deflated to set the container down on the dock and the loader returned to the shuttle for its next job.

Having thus described a few embodiments of my invention, these are not intended as a limitation on the scope of my invention which is intended to be covered by the claims to be submitted for this invention to include variations, applications, and parts which would be apparent to those skilled in the art and those within the spirit and scope of this invention.

I claim as my invention:

1. A cargo container transfer carrier (loader) that side-straddles the center sill of a vehicle to transfer a load, said carrier having a roadable running support that goes under the vehicle's center sill to support the carrier from tipping and a lift platform that extends out substantially as far as the roadable support over the sill of the vehicle and lifts to support a load from underneath for transfer to and from the vehicle, said carrier being limited in width to substantially the width of the vehicle for carrying the load substantially on center of the carrier which is within a traffic lane wide.

2. A carrier as in claim 1, said roadable running support having swivel ring casters spaced in said roadable support for supporting said carrier, said casters having a swivel ring, an axle supported substantially diametrically across said ring, at least one support wheel on each side of the center of said ring on said axle mounted to revolve separately and means to steer said casters each on their swivel axis intersecting said axis to turn said casters sideways or lengthways while said carrier is stationary.

3. In a carrier as in claim 2 said means to steer including a ring gear concentric about said ring, gearing and shafting connecting said ring gears to turn casters operable to steer said carrier.

4. A carrier as in claim 1, and a vehicle for carrying said loader, said vehicle having the center sill and platform beds between which the carrier enters, a shelf on each facing side of the vehicle platform beds below the top of the vehicle bed for the container and at least as high as the top of said sill to support and guide the ends of said load platform across the vehicle for travel thereon, leaving room for a load above on the vehicle, a lift connected between said roadable running support and said lift platform to lift and lower said roadable running support to stow said loader under the load on said vehicle for transport therewith.

5. In a combination as in claim 4, said lift when retracted around said center sill clamping said shelf at each end and the bottom of the sill between said lift platform and said roadable support for transport of said carrier underneath the space for the container.

6. A carrier as in claim 1 and a railway track, said vehicle being a railway car setting on said railway track, a driveway along side of and extending flush over said railway track for the carrier to run on to transfer to and from the railway car.

7. A carrier as in claim 1, said road running support including a first set of wheels for running and steering lengthwise, a second set of wheels mounted for rolling the carrier straight sideways, a lifting device for each said second set of wheels to extend (lower) these wheels to lift said carrier from said first set of wheels to a height to clear said carrier for running sideways under the center sill of, and any load on, the vehicle to substantially align a load central to the width of both the carrier and the vehicle for transversely centrally aligned transfer.

8. A carrier as in claim 7, said lifting device having additional lift left to extend said second set of wheels further to lift a load from the vehicle to clear for side transfer on the carrier.

9. A carrier as in claim 1 said lift platform including air lift bags connected for inflating to lift and deflate to lower a load on said lift platform for transfer to and from the carrier.

10. A carrier as in claim 1 said lift platform including scissor jacks connected to said roadable running support along one side of a vehicle sill and jack screws connected to operate said scissor jacks together for transfer of a load to and from the vehicle.
